(19) United States
(12) Patent Application Publication
(10) Pub. No.: US 2026/0004733 A1
(43) Pub. Date: Jan. 1, 2026

(54) Display Compensation Circuit, Source Circuit Board, Display Module, and Display Apparatus

(71) Applicant: Huawei Technologies Co., Ltd., Shenzhen (CN)

(72) Inventors: Wei Hsiang HUNG, Shenzhen (CN); Qinren Yao, Shanghai (CN); Jie Cui, Shenzhen (CN); Yanzhao Liang, Shenzhen (CN)

(73) Assignee: Huawei Technologies Co., Ltd., Shenzhen (CN)

(21) Appl. No.: 19/322,186

(22) Filed: Sep. 8, 2025

Related U.S. Application Data
(63) Continuation of application No. PCT/CN2023/135242, filed on Nov. 29, 2023.

(30) Foreign Application Priority Data
Mar. 9, 2023 (CN) 202310254909.9

(51) Int. Cl. G09G 3/3233; G09G 3/3275

(52) U.S. Cl. CPC G09G 3/3233; G09G 3/3275; G09G 2300/0809; G09G 2320/0223; G09G 2320/0233; G09G 2330/028

(57) ABSTRACT

Embodiments of this application provide a display compensation circuit, a source circuit board, a display module, and a display apparatus, and relate to the field of display technologies. The display compensation circuit may be integrated on a circuit board, the display compensation circuit includes a generation circuit and a calculation circuit that are electrically connected, and the generation circuit is configured to output a first reference gamma voltage and a second reference gamma voltage. The calculation circuit is configured to: receive a power supply voltage signal, and the first reference gamma voltage and the second reference gamma voltage that are from the generation circuit; and output a first gamma voltage signal and a second gamma voltage signal.

### CROSS-REFERENCE TO RELATED APPLICATIONS

This application is a continuation of International Application No. PCT/CN2023/135242, filed on Nov. 29, 2023, which claims priority to Chinese Patent Application No. 202310254909.9, filed on Mar. 9, 2023. The disclosures of the aforementioned applications are hereby incorporated by reference in their entireties.

### TECHNICAL FIELD

This application relates to the field of display technologies, and in particular, to a display compensation circuit, a source circuit board, a display module, and a display apparatus.

### BACKGROUND

Currently, an OLED (OLED) display apparatus gradually becomes one of mainstream display apparatuses by virtue of features such as self-emission, low drive power consumption, high light-emitting conversion efficiency, short response time, and low costs.

The OLED display apparatus includes a display panel. The display panel has a plurality of sub-pixels. Each sub-pixel includes a pixel drive circuit and a light emitting device. The pixel drive circuit drives the light emitting device to emit light, to implement display. Light emitting luminance of the light emitting device is related to a drive current flowing through the light emitting device. A larger drive current indicates higher light emitting luminance. The drive current is related to a power supply voltage signal received by the pixel drive circuit, and a larger voltage of the power supply voltage signal indicates a larger drive current.

Generally, the power supply voltage signal is provided by a power management integrated circuit (PMIC). The PMIC may be disposed on a main circuit board of the display apparatus, and is connected to the pixel drive circuit on the display panel through a trace. However, because the trace has a long length and a large resistance, a voltage drop (IR drop) occurs in a process of transmitting the power supply voltage signal through the trace. As a result, a voltage of the power supply voltage signal received by the pixel drive circuit is low, and a display picture of the display apparatus is dark.

### SUMMARY

Embodiments of this application provide a display compensation circuit, a source circuit board, a display module, and a display apparatus, to compensate for a voltage drop of a power supply voltage signal, so as to improve luminance of a display picture of the display apparatus.

To achieve the foregoing objectives, the following technical solutions are used in embodiments of this application.

According to a first aspect, a display compensation circuit is provided. The display compensation circuit may be integrated on a circuit board, the display compensation circuit includes a generation circuit and a calculation circuit that are electrically connected, and the generation circuit is configured to output a first reference gamma voltage and a second reference gamma voltage. The calculation circuit is configured to: receive a power supply voltage signal, and the first reference gamma voltage and the second reference gamma voltage that are from the generation circuit; and output a first gamma voltage signal and a second gamma voltage signal. The first gamma voltage signal is a voltage sum of the power supply voltage signal and the first reference gamma voltage, and the second gamma voltage signal is a voltage difference between the power supply voltage signal and the second reference gamma voltage.

According to the display compensation circuit provided in the foregoing embodiment of this application, the generation circuit outputs the first reference gamma voltage and the second reference gamma voltage, the calculation circuit is electrically connected to the generation circuit, and the calculation circuit receives the power supply voltage signal, and the first reference gamma voltage and the second reference gamma voltage that are from the generation circuit, and outputs the first gamma voltage signal and the second gamma voltage signal. The first gamma voltage signal is the voltage sum of the power supply voltage signal and the first reference gamma voltage, so that a voltage value of the power supply voltage signal is compensated in the first gamma voltage signal. The second gamma voltage signal is the voltage difference between the power supply voltage signal and the second reference gamma voltage, so that the voltage value of the power supply voltage signal is compensated in the second gamma voltage signal.

In view of this, the first gamma voltage signal and the second gamma voltage signal are input to a source driver, and the source driver generates and outputs a data voltage signal based on the first gamma voltage signal and the second gamma voltage signal. The voltage value of the power supply voltage signal is also compensated in the data voltage signal. The data voltage signal and the power supply voltage signal are input into a pixel drive circuit. A drive current output by the pixel drive circuit is positively correlated with a difference between the data voltage signal and the power supply voltage signal. Because the voltage value of the power supply voltage signal is compensated in the data voltage signal, the data voltage signal can cancel the power supply voltage signal. In this way, compensation for a voltage drop of the power supply voltage signal is implemented. This helps improve luminance of a display picture of a display apparatus.

In some embodiments, the calculation circuit includes an adder and a subtractor. The adder is electrically connected to the generation circuit. The adder is configured to calculate the voltage sum of the power supply voltage signal and the first reference gamma voltage, to obtain the first gamma voltage signal.

The subtractor is electrically connected to the generation circuit. The subtractor is configured to calculate the voltage difference between the power supply voltage signal and the second reference gamma voltage, to obtain the second gamma voltage signal.

In the foregoing embodiments, the adder is electrically connected to the generation circuit. The adder may receive the first reference gamma voltage from the generation circuit and the power supply voltage signal, and calculate the voltage sum of the power supply voltage signal and the first reference gamma voltage, to obtain the first gamma voltage signal.

The subtractor is electrically connected to the generation circuit. The subtractor may receive the second reference gamma voltage from the generation circuit and the power supply voltage signal, and calculate the voltage difference between the power supply voltage signal and the second reference gamma voltage, to obtain the second gamma voltage signal.

In view of this, the first gamma voltage signal and the second gamma voltage signal are input to the source driver, and the source driver generates and outputs the data voltage signal based on the first gamma voltage signal and the second gamma voltage signal. The voltage value of the power supply voltage signal is also compensated in the data voltage signal. When the data voltage signal and the power supply voltage signal are input into the pixel drive circuit, because the power supply voltage signal is compensated in the data voltage signal, compensation for the voltage drop of the power supply voltage signal can be implemented. This helps improve luminance of the display picture of the display apparatus.

In some embodiments, the adder includes a first operational amplifier, a first resistor, a second resistor, a third resistor, and a fourth resistor. The first resistor is electrically connected to a non-inverting input terminal of the first operational amplifier, and the non-inverting input terminal is configured to receive the power supply voltage signal through the first resistor; the second resistor is connected between the generation circuit and the non-inverting input terminal; the third resistor is connected between a first voltage terminal and an inverting input terminal of the first operational amplifier; and the fourth resistor is connected between the inverting input terminal and an output terminal of the first operational amplifier.

In the foregoing embodiments, the adder may calculate the voltage sum of the power supply voltage signal and the first reference gamma voltage, to obtain the first gamma voltage signal. The first operational amplifier in the adder is an analog circuit, and the first gamma voltage signal output by the first operational amplifier is an analog signal. The analog signal has features of precise resolution and easy processing. This helps improve precision of compensation for the power supply voltage signal.

In addition, a speed at which the adder generates the first gamma voltage signal may be adjusted by adjusting a load parameter of the first operational amplifier, to adjust a speed of compensating for the power supply voltage signal.

In some embodiments, the subtractor includes a second operational amplifier, a fifth resistor, a sixth resistor, a seventh resistor, and an eighth resistor. The fifth resistor is connected between a first voltage terminal and a non-inverting input terminal of the second operational amplifier; the sixth resistor is electrically connected to the non-inverting input terminal, and the non-inverting input terminal is configured to receive the power supply voltage signal through the sixth resistor; the seventh resistor is connected between the generation circuit and an inverting input terminal of the second operational amplifier; and the eighth resistor is connected between the inverting input terminal and an output terminal of the second operational amplifier.

In the foregoing embodiments, the subtractor may calculate the voltage difference between the power supply voltage signal and the second reference gamma voltage, to obtain the second gamma voltage signal. The second operational amplifier in the subtractor is an analog circuit, and the second gamma voltage signal output by the second operational amplifier is an analog signal. The analog signal has features of precise resolution and easy processing. This helps improve precision of compensation for the power supply voltage signal.

In addition, a speed at which the subtractor generates the second gamma voltage signal may be adjusted by adjusting a load parameter of the second operational amplifier, to adjust a speed of compensating for the power supply voltage signal.

In some embodiments, the generation circuit includes a signal generation sub-circuit and a voltage divider sub-circuit. The signal generation sub-circuit is configured to output a reference voltage signal. The voltage divider sub-circuit is electrically connected to the signal generation sub-circuit, and the voltage divider sub-circuit is configured to perform voltage division on the reference voltage signal, to obtain the first reference gamma voltage and the second reference gamma voltage.

In some embodiments, the voltage divider sub-circuit includes a first voltage divider resistor and a second voltage divider resistor that are disposed in series, and the first voltage divider resistor and the second voltage divider resistor are connected between the signal generation sub-circuit and a second voltage terminal.

The voltage divider sub-circuit further includes a first output terminal and a second output terminal. The first output terminal is connected between the first voltage divider resistor and the second voltage divider resistor, and the first output terminal is configured to output the first reference gamma voltage. The second output terminal is connected between the second voltage divider resistor and the second voltage terminal, and the second output terminal is configured to output the second reference gamma voltage.

According to a second aspect, a source circuit board is provided. The source circuit board includes a generation circuit and a calculation circuit that are electrically connected, and the generation circuit is configured to output a first reference gamma voltage and a second reference gamma voltage. The calculation circuit is configured to: receive a power supply voltage signal, and the first reference gamma voltage and the second reference gamma voltage that are from the generation circuit; and output a first gamma voltage signal and a second gamma voltage signal. The first gamma voltage signal is a voltage sum of the power supply voltage signal and the first reference gamma voltage, and the second gamma voltage signal is a voltage difference between the power supply voltage signal and the second reference gamma voltage.

According to the source circuit board provided in the foregoing embodiment of this application, the generation circuit outputs the first reference gamma voltage and the second reference gamma voltage, the calculation circuit is electrically connected to the generation circuit, and the calculation circuit receives the power supply voltage signal, and the first reference gamma voltage and the second reference gamma voltage that are from the generation circuit, and outputs the first gamma voltage signal and the second gamma voltage signal. The first gamma voltage signal is the voltage sum of the power supply voltage signal and the first reference gamma voltage, so that a voltage value of the power supply voltage signal is compensated in the first gamma voltage signal. The second gamma voltage signal is the voltage difference between the power supply voltage signal and the second reference gamma voltage, so that the voltage value of the power supply voltage signal is compensated in the second gamma voltage signal.

In view of this, the first gamma voltage signal and the second gamma voltage signal are input to a source driver, and the source driver generates and outputs a data voltage signal based on the first gamma voltage signal and the second gamma voltage signal. The voltage value of the power supply voltage signal is also compensated in the data voltage signal. The data voltage signal and the power supply voltage signal are input into a pixel drive circuit. A drive current output by the pixel drive circuit is positively correlated with a difference between the data voltage signal and the power supply voltage signal. Because the voltage value of the power supply voltage signal is compensated in the data voltage signal, the data voltage signal can cancel the power supply voltage signal. In this way, compensation for a voltage drop of the power supply voltage signal is implemented. This helps improve luminance of a display picture of a display apparatus.

In addition, a display compensation circuit is integrated on the source circuit board, and only a corresponding circuit component needs to be added on the source circuit board. A quantity of added circuit components is small. Therefore, an occupied area of the source circuit board is small, and product costs are low. In addition, an area occupied by adding the compensation circuit on a display panel can be avoided, to avoid a decrease in pixel density of the display panel.

In some embodiments, the source circuit board further includes a time sequence controller. The time sequence controller is electrically connected to a signal generation sub-circuit of the generation circuit. The time sequence controller is configured to control the signal generation sub-circuit to output a reference voltage signal, so that a voltage divider sub-circuit performs voltage division on the reference voltage signal, to obtain the first reference gamma voltage and the second reference gamma voltage.

According to a third aspect, a display module is provided. The display module includes a display panel, at least one source driver, and the display compensation circuit according to any one of the foregoing embodiments. The display panel includes a plurality of data lines, and the source driver is electrically connected to the plurality of data lines. The calculation circuit of the display compensation circuit is electrically connected to the source driver, and the calculation circuit is configured to transmit the first gamma voltage signal and the second gamma voltage signal to the source driver.

According to the display module provided in the foregoing embodiment of this application, in the display compensation circuit, the calculation circuit is electrically connected to the generation circuit, and the calculation circuit receives the power supply voltage signal, and the first reference gamma voltage and the second reference gamma voltage that are from the generation circuit. In addition, the calculation circuit may obtain the first gamma voltage signal based on the power supply voltage signal and the first reference gamma voltage, so that the power supply voltage signal is compensated in the first gamma voltage signal. The calculation circuit may further obtain the second gamma voltage signal based on the power supply voltage signal and the second reference gamma voltage, so that the power supply voltage signal is compensated in the second gamma voltage signal.

In view of this, the first gamma voltage signal and the second gamma voltage signal are input to the source driver, and the source driver generates and outputs a data voltage signal based on the first gamma voltage signal and the second gamma voltage signal. The power supply voltage signal is also compensated in the data voltage signal. When the data voltage signal and the power supply voltage signal are input into a pixel drive circuit, because the power supply voltage signal is compensated in the data voltage signal, compensation for a voltage drop of the power supply voltage signal can be implemented. This helps improve luminance of a display picture of a display apparatus.

In addition, when the display module includes a plurality of source drivers, the plurality of source drivers receive gamma voltage signals output by a same calculation circuit, and compensation amounts of the gamma voltage signals received by the plurality of source drivers are the same, so that compensation amounts of data voltage signals generated by different source drivers are the same. In this way, a plurality of columns of sub-pixels corresponding to the different source drivers are displayed synchronously, to avoid screen splitting of a picture displayed on the display panel, and to improve quality of the displayed picture.

In some embodiments, the display module includes a source circuit board, and the source circuit board includes the display compensation circuit.

The display compensation circuit is integrated on the source circuit board, so that an area occupied by adding the compensation circuit on the display panel can be avoided, to avoid a decrease in pixel density of the display panel.

According to a fourth aspect, a display apparatus is provided. The display apparatus includes the display module according to any one of the foregoing embodiments and a power supply circuit. The power supply circuit is electrically connected to the calculation circuit of the display compensation circuit, and the power supply circuit is configured to transmit the power supply voltage signal to the calculation circuit.

In some embodiments, the display apparatus includes a main circuit board, and the main circuit board includes the foregoing power supply circuit.

It may be understood that, for beneficial effect that can be achieved by the display apparatus provided in the foregoing embodiments of this application, refer to the foregoing beneficial effect of the display compensation circuit. Details are not described herein again.

### BRIEF DESCRIPTION OF DRAWINGS

To describe technical solutions in this application more clearly, the following briefly describes accompanying drawings used in describing some embodiments of this application. It is clear that the accompanying drawings in the following descriptions are merely accompanying drawings in some embodiments of this application. A person of ordinary skill in the art may further derive other drawings from these accompanying drawings. In addition, the accompanying drawings in the following descriptions may be considered as diagrams, and are not intended to limit an actual size of a product, an actual procedure of a method, an actual time sequence of a signal, and the like in embodiments of this application.

FIG. 1 is a diagram of a structure of a display apparatus according to an embodiment of this application;

FIG. 2 is a diagram of another structure of a display apparatus according to an embodiment of this application;

FIG. 3 is a diagram of a structure of a display panel according to an embodiment of this application;

FIG. 4 is a diagram of a pixel architecture of a display panel according to an embodiment of this application;

FIG. 5 is a diagram of yet another structure of a display apparatus according to an embodiment of this application;

FIG. 6 is a block diagram of a structure of a display compensation circuit according to an embodiment of this application;

FIG. 7 is a diagram of a structure of a display compensation circuit according to an embodiment of this application; and

FIG. 8 is a block diagram of a structure of a source circuit board according to an embodiment of this application.

### DESCRIPTION OF EMBODIMENTS

The following clearly describes technical solutions in some embodiments of this application with reference to accompanying drawings. It is clear that the described embodiments are merely some rather than all of embodiments of this application. All other embodiments obtained by a person of ordinary skill in the art based on embodiments of this application shall fall within the protection scope of this application.

In the descriptions of this application, it should be understood that directions or position relationships indicated by the terms such as “center”, “up”, “down”, “front”, “rear”, “left”, “right”, “vertical”, “horizontal”, “top”, “bottom”, “inside”, and “outside” are based on the directions or the position relationships shown in the accompanying drawings, and are merely intended to describe this application and simplify the descriptions, but not intended to indicate or imply that an indicated apparatus or component has a specific direction or is formed and operated in a specific direction, and therefore cannot be understood as a limitation on this application.

Unless otherwise required by the context, throughout the specification and claims, the term “include” is interpreted as “open and inclusive”, that is, “include but not limited to”. In the descriptions of the specification, terms such as “an embodiment”, “some embodiments”, “example embodiments”, “examples”, or “some examples” are intended to indicate that specific features, structures, materials, or characteristics related to embodiments or the examples are included in at least one embodiment or example of this application. The foregoing schematic representations of the terms do not necessarily refer to a same embodiment or example. Further, the particular feature, structure, material, or characteristic may be included in any one or more embodiments or examples in any appropriate manner.

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In the descriptions of embodiments of this application, “a plurality of” means two or more than two unless otherwise specified.

When some embodiments are described, expressions of “connection” and extensions thereof may be used. For example, when some embodiments are described, the term “connection” may be used to indicate that two or more components are in direct physical contact or electrical contact with each other. Embodiments of this application herein are not necessarily limited to content of this specification.

“A and/or B” includes the following three combinations: only A, only B, and a combination of A and B.

The use of “configured to” in this specification implies an open and inclusive language, and does not exclude a device that is applicable to or configured to perform an additional task or step.

In addition, the use of “based on” means openness and inclusiveness, since processes, steps, calculation, or other actions “based on” one or more of conditions or values may be based in practice on additional conditions or values outside the described values.

In the content of this application, the meanings of “on”, “above”, and “on the top of” should be interpreted in a broadest manner, so that “on” means not only “directly on something”, but also includes the meaning of “on something” with an intermediate feature or layer between associated objects, and “above” or “on the top of” not only means “above” or “on the top of” something, but also includes the meaning of being “above” or “on the top of” something (that is, directly on something) without the intermediate feature or layer between the associated objects.

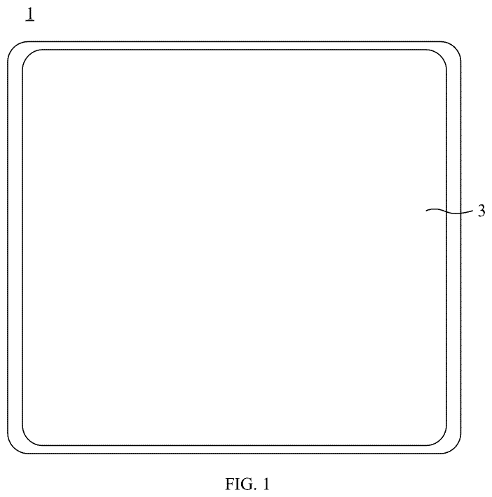

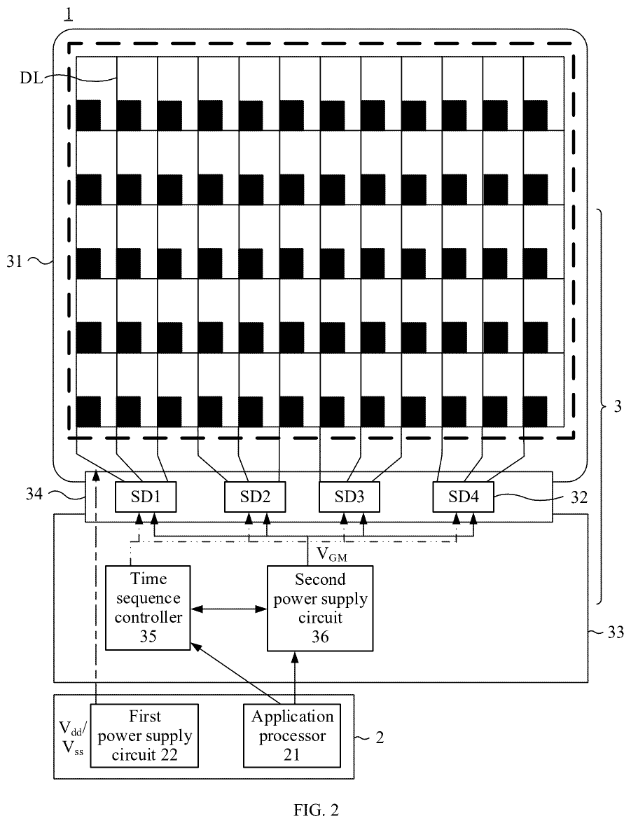

Some embodiments of this application provide a display apparatus. FIG. 1 is a diagram of a structure of a display apparatus according to an embodiment of this application. FIG. 2 is a diagram of another structure of a display apparatus according to an embodiment of this application.

Refer to FIG. 1. The display apparatus 1 may be any apparatus that displays either dynamic content (for example, video) or static content (for example, still images) and either a text or an image. More specifically, embodiments are contemplated to be implemented in or in association with a variety of electronic apparatuses, such as (but not limited to) a mobile phone, a wireless apparatus, a personal data assistant, a handheld or portable computer, a GPS receiver/navigator, a camera, an MP4 video player, a video camera, a game console, a watch, a clock, a calculator, a television monitor, a flat-panel display, a computer monitor, a car display (for example, an odometer display), a navigator, a cockpit controller and/or display, a display of a camera view (for example, a display of a rear-view camera in a vehicle), an electronic photo, an electronic billboard or signboard, a projector, a building structure, a packaging, and an aesthetic structure (for example, a display of an image of a jewelry).

The following embodiments are described by using an example in which the display apparatus 1 is an OLED display apparatus.

Refer to FIG. 1 and FIG. 2. The display apparatus 1 includes a main circuit board 2 and a display module 3.

The main circuit board 2 includes an application processor (AP) 21 and a first power supply circuit 22.

The application processor 21 may generate a corresponding time sequence control signal and display data based on an external signal source.

The first power supply circuit 22 is a power management integrated circuit (PMIC), and the first power supply circuit 22 is configured to output a first power supply voltage signal V_{dd} and a second power supply voltage signal Vₛₛ. The first power supply voltage signal V_{dd} is, for example, a high-level signal, and the second power supply voltage signal Vₛₛ is, for example, a low-level signal.

The display module 3 includes a display panel 31, at least one source driver (SD) 32, and a source circuit board 33. The at least one source driver 32 is electrically connected to the display panel 31.

For example, the display module 3 further includes a flexible printed circuit (FPC) 34. The source driver 32 may be disposed on the flexible printed circuit 34, and is bonded (bonding) to the display panel 31 through the flexible printed circuit 34. In this way, the source driver 32 is electrically connected to the display panel 31.

For example, there may be one or more source drivers 32, and a quantity of source drivers 32 may be set based on a size of the display panel 31. For example, the quantity of source drivers 32 may be 1, 2, 4, 8, . . . , or the like.

FIG. 2 shows a case in which the display module includes four source drivers. The four source drivers are respectively SD1, SD2, SD3, and SD4.

Still refer to FIG. 2. The source circuit board 33 includes a time sequence controller 35 and a second power supply circuit 36 that are connected.

For example, the time sequence controller 35 is electrically connected to the second power supply circuit 36 through a two-wire serial bus (Inter-Integrated Circuit, I2C for short).

For example, the second power supply circuit 36 is also a PMIC. For example, the second power supply circuit 36 may be a direct current-direct current converter (DC-DC).

The time sequence controller 35 is electrically connected to the application processor 21 and the source driver 32. The time sequence controller 35 may receive a plurality of time sequence control signals and display data from the application processor 21, convert the plurality of time sequence control signals into control signals that can be identified by the source driver 32, output the control signals to the source driver 32, convert the display data into a data signal (where the data signal is a digital signal), and output the data signal to the source driver 32.

The second power supply circuit 36 is electrically connected to the source driver 32. The time sequence controller 35 may further control the second power supply circuit 36 to generate a gamma voltage signal V_{GM}, and output the gamma voltage signal V_{GM} to the source driver 32. The source driver 32 may generate and output a plurality of gray-scale voltages (a data voltage signal V_{data}, which is an analog signal) based on the gamma voltage signal V_{GM}.

Generally, there are a plurality of gamma voltage signals V_{GM}, and a larger quantity of gamma voltage signals V_{GM} indicates finer generated gray-scale voltages and higher quality of a displayed picture. In addition, the quantity of gamma voltage signals V_{GM} is an even number. For example, the gamma voltage signal V_{GM} includes a first gamma voltage signal V_{GMH} and a second gamma voltage signal V_{GML}, the first gamma voltage signal V_{GMH} is a high-level signal, and the second gamma voltage signal V_{GML} is a low-level signal.

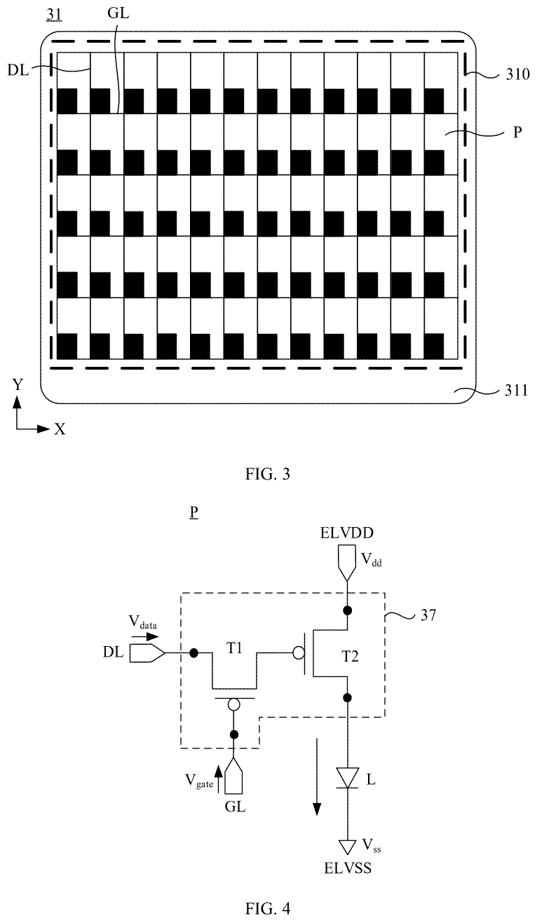

FIG. 3 is a diagram of a structure of a display panel according to an embodiment of this application. FIG. 4 is a diagram of a pixel architecture of a display panel according to an embodiment of this application.

Refer to FIG. 3. The display panel 31 includes a display area (AA) 310 and a peripheral area 311 located on at least one side of the display area 310.

A plurality of sub-pixels (sub-pixels) P are disposed in the display area 310. For ease of description, an example in which the plurality of sub-pixels P are arranged in an array is used for description in this application. The plurality of sub-pixels P are arranged in a plurality of rows and a plurality of columns, each row of sub-pixels P is arranged in a first direction X, each column of sub-pixels P is arranged in a second direction Y, and the first direction X intersect with the second direction Y. For example, the first direction X and the second direction Y are perpendicular to each other. One row of sub-pixels P may be connected to one gate line GL (Gate Line), and one column of sub-pixels P may be connected to one data line DL (Data Line).

Refer to FIG. 2 and FIG. 3. The source driver 32 is electrically connected to a plurality of data lines DL on the display panel 31, and the source driver 32 may transmit a data voltage signal V_{data} to the plurality of data lines DL.

Refer to FIG. 4. The sub-pixel P includes a pixel drive circuit 37 and a light emitting device L, and the pixel drive circuit 37 drives the light emitting device L to emit light, to display the sub-pixel P.

For example, the pixel drive circuit 37 includes a first transistor T1, a second transistor T2, a gate line GL, a data line DL, a first power supply voltage terminal ELVDD, and a second power supply voltage terminal ELVSS, and both the first transistor T1 and the second transistor T2 may be, for example, thin film transistors (TFTs). For the first transistor T1, a control electrode is connected to the gate line GL, a first electrode is connected to the data line DL, and a second electrode is connected to a control electrode of the second transistor T2. For the second transistor T2, a first electrode is connected to the first power supply voltage terminal ELVDD, and a second electrode is connected to the light emitting device L.

The light emitting device L is connected between the second electrode of the second transistor T2 and the second power supply voltage terminal ELVSS.

Under control of a gate scanning signal V_{gate} from the gate line GL, the first transistor T1 is turned on, and the data voltage signal V_{data} from the data line DL is transmitted to the control electrode of the second transistor T2 through the first transistor T1. Under control of the data voltage signal V_{data}, the second transistor T2 is turned on, a drive current is generated under action of the first supply voltage signal V_{dd} from the first power supply voltage terminal ELVDD and the second power supply voltage signal Vₛₛ from the second power supply voltage terminal ELVSS, and the drive current flows into the light emitting device L through the second transistor T2, to drive the light emitting device L to emit light.

It may be understood that the first transistor T1 is used as a switch of the pixel drive circuit 37, and the first transistor T1 is also referred to as a switch transistor. The second transistor T2 is configured to output a current to the light emitting device L, and the second transistor T2 is also referred to as a drive transistor.

The following Formula (1) is a formula for calculating a drive current:

$${I}_{ds} = \frac{1}{2} \times μ \times {C}_{ox} \times \frac{W}{L} \times {( {V}_{gs} - {V}_{th} )}^{2} \qquad ( 1 )$$

Herein, I_{ds} is a saturation current (namely, the drive current) of the second transistor T2; μ is a carrier mobility of the second transistor T2; Cₒₓ is a channel capacitance per unit area of the second transistor T2;

$$\frac{W}{L}$$

is a channel width-to-length ratio of the second transistor T2; V_{gs} is a gate-source voltage difference of the second transistor T2; and Vₜₕ is a threshold voltage of the second transistor T2.

For example, the second transistor T2 is a P-type transistor. The threshold voltage Vₜₕ of the second transistor T2 is a negative value. Based on a conduction characteristic of the P-type transistor, when the gate-source voltage difference V_{gs} of the second transistor T2 is less than the threshold voltage Vₜₕ of the second transistor T2, the second transistor T2 is turned on.

In other words, when the second transistor T2 is turned on, the gate-source voltage difference V_{gs} of the second transistor T2 is also a negative value. Because the gate-source voltage difference V_{gs} of the second transistor T2 is equal to V_{data}−V_{dd}, a voltage value of the data voltage signal V_{data} is less than a voltage value of the first power supply voltage signal V_{dd}.

It can be learned with reference to Formula (1) that, when the second transistor T2 is turned on, a smaller gate-source voltage difference V_{gs} of the second transistor T2 indicates a larger drive current I_{ds} and higher light emitting luminance of the light emitting device L.

Generally, the first power supply voltage terminal ELVDD and the second power supply voltage terminal ELVSS are separately electrically connected to the first power supply circuit 22 on the main circuit board 2 through a trace. The first power supply voltage terminal ELVDD receives the first power supply voltage signal V_{dd} from the first power supply circuit 22. The second power supply voltage terminal ELVSS receives the second power supply voltage signal Vₛₛ from the first power supply circuit 22.

However, because there is a distance between the main circuit board 2 and the display panel 31, the trace has a long length and a large resistance, and a voltage drop (IR drop) occurs in a process of transmitting the first power supply voltage signal V_{dd} and the second power supply voltage signal Vₛₛ on the trace. As a result, a voltage of the first power supply voltage signal V_{dd} received by the pixel drive circuit 37 is low, the gate-source voltage difference V_{gs} of the second transistor T2 increases, and the drive current I_{ds} decreases. Consequently, a display picture of the display panel 31 is dark.

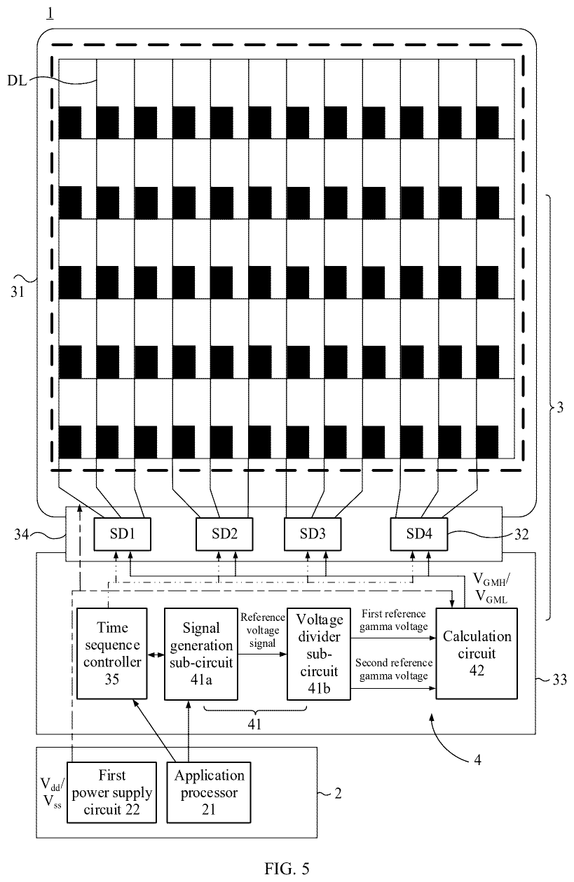

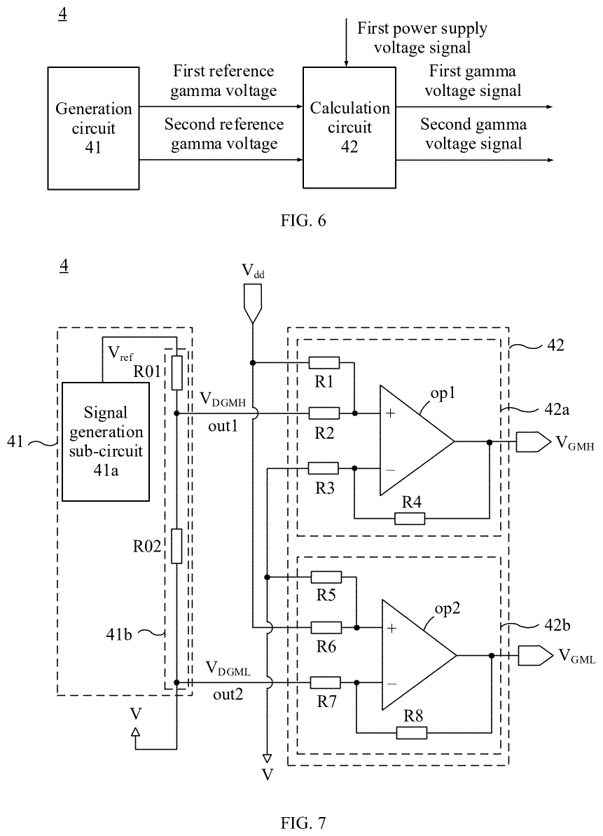

To resolve the foregoing problem, some embodiments of this application provide a display apparatus. FIG. 5 is a diagram of another structure of a display apparatus according to an embodiment of this application. FIG. 6 is a block diagram of a structure of a display compensation circuit according to an embodiment of this application.

Refer to FIG. 5 and FIG. 6. The display compensation circuit 4 includes a generation circuit 41 and a calculation circuit 42.

The generation circuit 41 is configured to output a first reference gamma voltage V_{DGMH} and a second reference gamma voltage V_{DGML}, where voltage values of the first reference gamma voltage V_{DGMH} and the second reference gamma voltage V_{DGML} are both fixed values. For example, the first reference gamma voltage V_{DGMH} is a high-level signal, and the second reference gamma voltage V_{DGML} is a low-level signal.

For example, the generation circuit 41 includes a signal generation sub-circuit 41a and a voltage divider sub-circuit 41b.

The calculation circuit 42 is electrically connected to the first power supply circuit 22 and the generation circuit 41, and the calculation circuit 42 is configured to receive the first power supply voltage signal V_{dd} from the first power supply circuit 22 and the first reference gamma voltage V_{DGMH} and the second reference gamma voltage V_{DGML} that are from the generation circuit 41, and output a first gamma voltage signal V_{GMH} and a second gamma voltage signal V_{GML}. The first gamma voltage signal V_{GMH} is a voltage sum of the first power supply voltage signal V_{dd} and the first reference gamma voltage V_{DGMH}, and the second gamma voltage signal V_{GML} is a voltage difference between the first power supply voltage signal V_{dd} and the second reference gamma voltage V_{DGML}.

Refer to FIG. 5. It may be understood that the first gamma voltage signal V_{GMH} is a high-level signal, and the second gamma voltage signal V_{GML} is a low-level signal. The calculation circuit 42 is further electrically connected to the source driver 32, and the calculation circuit 42 transmits the first gamma voltage signal V_{GMH} and the second gamma voltage signal V_{GML} to the source driver 32. Further, the source driver 32 may generate and output a plurality of data voltage signals V_{data} based on the first gamma voltage signal V_{GMH} and the second gamma voltage signal V_{GML}, and transmit the plurality of data voltage signals V_{data} to the pixel drive circuit 37 through a plurality of data lines DL.

According to the display compensation circuit 4 provided in the foregoing embodiments of this application, the generation circuit 41 outputs the first reference gamma voltage V_{DGMH} and the second reference gamma voltage V_{DGML}. The calculation circuit 42 is electrically connected to the generation circuit 41, and the calculation circuit 42 receives the first power supply voltage signal V_{dd} from the first power supply circuit 22, and the first reference gamma voltage V_{DGMH} and the second reference gamma voltage V_{DGML} that are from the generation circuit 41, and outputs the first gamma voltage signal V_{GMH} and the second gamma voltage signal V_{GML}. The first gamma voltage signal V_{GMH} is the voltage sum of the first power supply voltage signal V_{dd} and the first reference gamma voltage V_{DGMH}, so that a voltage value of the first power supply voltage signal V_{dd} is compensated in the first gamma voltage signal V_{GMH}. The second gamma voltage signal V_{GML} is the voltage difference between the first power supply voltage signal V_{dd} and the second reference gamma voltage V_{DGML}, so that the voltage value of the first power supply voltage signal V_{dd} is compensated in the second gamma voltage signal V_{GML}.

In view of this, the first gamma voltage signal V_{GMH} and the second gamma voltage signal V_{GML} are input to the source driver 32, and the source driver 32 generates and outputs the data voltage signal V_{data} based on the first gamma voltage signal V_{GMH} and the second gamma voltage signal V_{GML}. The voltage value of the first power supply voltage signal V_{dd} is also compensated in the data voltage signal V_{data}. The data voltage signal V_{data} and the first power supply voltage signal V_{dd} are input to the pixel drive circuit 37. Because the voltage value of the first power supply voltage signal V_{dd} is compensated in the data voltage signal V_{data}, and the gate-source voltage difference V_{gs} of the second transistor T2 is equal to V_{data}−V_{dd}, impact of the first power supply voltage signal V_{dd} on the gate-source voltage difference V_{gs} of the second transistor T2 can be eliminated, to compensate for a voltage drop of the first power supply voltage signal V_{dd}. In this way, a problem that the gate-source voltage difference V_{gs} of the second transistor T2 increases and the drive current I_{ds} decreases due to the voltage drop of the first power supply voltage signal V_{dd} can be avoided. This helps improve luminance of the display picture of the display panel 31.

In a related technology, a compensation circuit is disposed inside a source driver, to compensate for a data voltage signal output by the source driver. However, when a display module includes a plurality of source drivers, compensation amounts and compensation speeds of different source drivers for the data voltage signal are easily different, resulting in asynchronous display of a plurality of columns of sub-pixels corresponding to the different source drivers and splitting of a display picture.

However, in the foregoing embodiments of this application, when the display module 3 includes a plurality of source drivers 32, the plurality of source drivers 32 receive gamma voltage signals output by a same calculation circuit 42. In other words, compensation amounts of the gamma voltage signals received by the plurality of source drivers 32 are the same, so that compensation amounts of data voltage signals V_{data} generated by different source drivers 32 are the same. In this way, a plurality of columns of sub-pixels corresponding to the different source drivers are displayed synchronously, to avoid screen splitting of a picture displayed on the display panel 31, and to improve quality of the displayed picture.

FIG. 7 is a diagram of a structure of a display compensation circuit according to an embodiment of this application.

Refer to FIG. 7. The signal generation sub-circuit 41a is configured to output a reference voltage signal V_{ref}. For example, the signal generation sub-circuit 41a may be the second power supply circuit 36 described above.

The voltage divider sub-circuit 41b is electrically connected to the signal generation sub-circuit 41a, and the voltage divider sub-circuit 41b is configured to perform voltage division on the reference voltage signal V_{ref}, to obtain the first reference gamma voltage V_{DGMH} and the second reference gamma voltage V_{DGML}.

For example, the voltage divider sub-circuit 41b may be a resistive voltage divider, and the voltage divider sub-circuit 41b includes a first voltage divider resistor R01 and a second voltage divider resistor R02 that are disposed in series. The first voltage divider resistor R01 and the second voltage divider resistor R02 are connected between the signal generation sub-circuit 41a and a voltage terminal V.

For example, the voltage terminal V may be a ground terminal GND.

The voltage divider sub-circuit 41b further includes a first output terminal out1 and a second output terminal out2. The first output terminal out1 is connected between the first voltage divider resistor R01 and the second voltage divider resistor R02, and the first output terminal out1 is configured to output the first reference gamma voltage V_{DGMH}. The second output terminal out2 is connected between the second voltage divider resistor R02 and the voltage terminal V, and the second output terminal out2 is configured to output the second reference gamma voltage V_{DGML}.

Refer to FIG. 7. In some embodiments, the calculation circuit 42 includes an adder 42a and a subtractor 42b.

The adder 42a is electrically connected to the generation circuit 41, and the adder 42a is configured to calculate a voltage sum of the first power supply voltage signal V_{dd} and the first reference gamma voltage V_{DGMH}, to obtain the first gamma voltage signal V_{GMH}.

For example, the adder 42a is electrically connected to the first power supply circuit 22 and the first output terminal out1 of the voltage divider sub-circuit 41b.

The subtractor 42b is electrically connected to the generation circuit 41, and the subtractor 42b is configured to calculate the voltage difference between the first power supply voltage signal V_{dd} and the second reference gamma voltage V_{DGML}, to obtain the second gamma voltage signal V_{GML}.

For example, the subtractor 42b is electrically connected to the first power supply circuit 22 and the second output terminal out2 of the voltage divider sub-circuit 41b.

In the foregoing embodiments, the adder 42a is electrically connected to the generation circuit 41, and the adder 42a may receive the first power supply voltage signal V_{dd} from the first power supply circuit 22 and the first reference gamma voltage V_{DGMH} from the generation circuit 41, and calculate the voltage sum of the first power supply voltage signal V_{dd} and the first reference gamma voltage V_{DGMH}, to obtain the first gamma voltage signal V_{GMH}, that is, V_{GMH}=V_{dd}+V_{DGMH}.

The subtractor 42b is electrically connected to the generation circuit 41, and the subtractor 42b may receive the first power supply voltage signal V_{dd} from the first power supply circuit 22 and the second reference gamma voltage V_{DGML} from the generation circuit 41, and calculate the voltage difference between the first power supply voltage signal V_{dd} and the second reference gamma voltage V_{DGML}, to obtain the second gamma voltage signal V_{GML}, that is,

$${V}_{GML} = {V}_{dd} - {V}_{DGML} .$$

In view of this, the first gamma voltage signal V_{GMH} and the second gamma voltage signal V_{GML} are input to the source driver 32, and the source driver 32 generates and outputs the data voltage signal V_{data} based on the first gamma voltage signal V_{GMH} and the second gamma voltage signal V_{GML}. The voltage value of the first power supply voltage signal V_{dd} is also compensated in the data voltage signal V_{data}. The data voltage signal V_{data} and the first power supply voltage signal V_{dd} are input to the pixel drive circuit 37. Because the voltage value of the first power supply voltage signal V_{dd} is compensated in the data voltage signal V_{data}, and the gate-source voltage difference V_{gs} of the second transistor T2 is equal to V_{data}−V_{dd}, impact of the first power supply voltage signal V_{dd} on the gate-source voltage difference V_{gs} of the second transistor T2 can be eliminated, to compensate for the voltage drop of the first power supply voltage signal V_{dd}. In this way, a problem that the gate-source voltage difference V_{gs} of the second transistor T2 increases and the drive current I_{ds} decreases due to the voltage drop of the first power supply voltage signal V_{dd} can be avoided. This helps improve luminance of the display picture of the display panel 31.

Refer to FIG. 7. In some embodiments, the adder 42a includes a first operational amplifier op1, a first resistor R1, a second resistor R2, a third resistor R3, and a fourth resistor R4.

The first resistor R1 is electrically connected to a non-inverting input terminal of the first operational amplifier op1, and the non-inverting input terminal may receive the first power supply voltage signal V_{dd} through the first resistor R1. The second resistor R2 is connected between the generation circuit 41 and the non-inverting input terminal of the first operational amplifier op1. The third resistor R3 is connected between the voltage terminal V and an inverting input terminal of the first operational amplifier op1. The fourth resistor R4 is connected between the inverting input terminal and an output terminal of the first operational amplifier op1. The output terminal of the first operational amplifier op1 is configured to output the first gamma voltage signal V_{GMH}, and the output terminal of the first operational amplifier may further be connected in series to a component (for example, a resistor or a capacitor). The component may be used as a load of the first operational amplifier op1.

It may be understood that the operational amplifier is an analog circuit, and the first gamma voltage signal V_{GMH} output by the first operational amplifier op1 is an analog signal. The analog signal has features of accurate resolution and easy processing. This helps improve compensation precision for the first power supply voltage signal V_{dd}.

In addition, a speed at which the adder 42a generates the first gamma voltage signal V_{GMH} may be adjusted by adjusting a load parameter of the first operational amplifier op1, to adjust a speed of compensating for the first power supply voltage signal V_{dd}.

Refer to FIG. 7. In some embodiments, the subtractor 42b includes a second operational amplifier op2, a fifth resistor R5, a sixth resistor R6, a seventh resistor R7, and an eighth resistor R8.

The fifth resistor R5 is connected between the voltage terminal V and a non-inverting input terminal of the second operational amplifier op2. The sixth resistor R6 is electrically connected to the non-inverting input terminal of the second operational amplifier op2. The non-inverting input terminal may receive the first power supply voltage signal V_{dd} through the sixth resistor R6. The seventh resistor R7 is connected between the generation circuit 41 and an inverting input terminal of the second operational amplifier op2. The eighth resistor R8 is connected between the inverting input terminal and an output terminal of the second operational amplifier op2. The output terminal of the second operational amplifier op2 is configured to output the second gamma voltage signal V_{GML}, and the output terminal of the second operational amplifier may further be connected in series to a component (for example, a resistor or a capacitor). The component may be used as a load of the second operational amplifier op2.

It may be understood that the operational amplifier is an analog circuit, and the second gamma voltage signal V_{GML} output by the second operational amplifier op2 is an analog signal. The analog signal has features of accurate resolution and easy processing. This helps improve compensation precision for the first power supply voltage signal V_{dd}.

In addition, a speed at which the subtractor 42b generates the second gamma voltage signal V_{GML} may be adjusted by adjusting a load parameter of the second operational amplifier op2, to adjust a speed of compensating for the first power supply voltage signal V_{dd}.

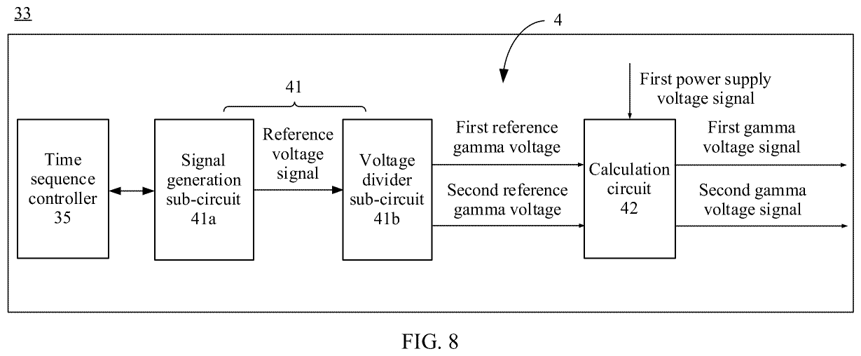

Some embodiments of this application further provide a source circuit board. FIG. 8 is a block diagram of a structure of a source circuit board according to an embodiment of this application.

Refer to FIG. 8. The source circuit board 33 includes the display compensation circuit 4 in any one of the foregoing embodiments. It may be understood that both the generation circuit 41 and the calculation circuit 42 in the display compensation circuit 4 are integrated on the source circuit board 33.

According to the source circuit board 33 provided in the foregoing embodiments of this application, the source circuit board 33 includes the display compensation circuit 4. In the display compensation circuit 4, the calculation circuit 42 is electrically connected to the generation circuit 41, and the calculation circuit 42 receives the first power supply voltage signal V_{dd}, and the first reference gamma voltage V_{DGMH} and the second reference gamma voltage V_{DGML} that are from the generation circuit 41, and outputs the first gamma voltage signal V_{GMH} and the second gamma voltage signal V_{GML}. The first gamma voltage signal V_{GMH} is the voltage sum of the first power supply voltage signal V_{dd} and the first reference gamma voltage V_{DGMH}, so that the voltage value of the first power supply voltage signal V_{dd} is compensated in the first gamma voltage signal V_{GMH}. The second gamma voltage signal V_{GML} is the voltage difference between the first power supply voltage signal V_{dd} and the second reference gamma voltage V_{DGML}, so that the voltage value of the first power supply voltage signal V_{dd} is compensated in the second gamma voltage signal V_{GML}.

In view of this, the first gamma voltage signal V_{GMH} and the second gamma voltage signal V_{GML} are input to the source driver 32, and the source driver 32 generates and outputs the data voltage signal V_{data} based on the first gamma voltage signal V_{GMH} and the second gamma voltage signal V_{GML}. The voltage value of the first power supply voltage signal V_{dd} is also compensated in the data voltage signal V_{data}. The data voltage signal V_{data} and the first power supply voltage signal V_{dd} are input to the pixel drive circuit 37. Because the voltage value of the first power supply voltage signal V_{dd} is compensated in the data voltage signal V_{data}, and the gate-source voltage difference V_{gs} of the second transistor T2 is equal to V_{data}−V_{dd}, impact of the first power supply voltage signal V_{dd} on the gate-source voltage difference V_{gs} of the second transistor T2 can be eliminated, to compensate for a voltage drop of the first power supply voltage signal V_{dd}. In this way, a problem that the gate-source voltage difference V_{gs} of the second transistor T2 increases and the drive current I_{ds} decreases due to the voltage drop of the first power supply voltage signal V_{dd} can be avoided. This helps improve luminance of the display picture of the display panel 31.

In addition, the display compensation circuit 4 is integrated on the source circuit board 33, and only a corresponding circuit component needs to be added on the source circuit board 33. A quantity of added circuit components is small. Therefore, an occupied area of the source circuit board 33 is small, and product costs are low. In addition, an area occupied by adding the compensation circuit on the display panel 31 can be avoided, to avoid a decrease in pixel density of the display panel 31.

Refer to FIG. 8. In some embodiments, the source circuit board 33 further includes the time sequence controller 35. The time sequence controller 35 is electrically connected to the signal generation sub-circuit 41a of the generation circuit 41. The time sequence controller 35 is configured to control the signal generation sub-circuit 41a to output the reference voltage signal V_{ref}, so that the voltage divider sub-circuit 41b performs voltage division on the reference voltage signal V_{ref}, to obtain the first reference gamma voltage V_{DGMH} and the second reference gamma voltage V_{DGML}.

According to the display compensation circuit, the source circuit board, the display module, and the display apparatus provided in some embodiments of this application, in the display compensation circuit, the calculation circuit is electrically connected to the generation circuit, and the calculation circuit receives the first power supply voltage signal, and the first reference gamma voltage and the second reference gamma voltage that are from the generation circuit, and outputs the first gamma voltage signal and the second gamma voltage signal. The first gamma voltage signal is the voltage sum of the first power supply voltage signal and the first reference gamma voltage, so that the voltage value of the first power supply voltage signal is compensated in the first gamma voltage signal. The second gamma voltage signal is the voltage difference between the first power supply voltage signal and the second reference gamma voltage, so that the voltage value of the first power supply voltage signal is compensated in the second gamma voltage signal.

The calculation circuit outputs the first gamma voltage signal and the second gamma voltage signal to the source driver, and the source driver generates and outputs the data voltage signal based on the first gamma voltage signal and the second gamma voltage signal. The voltage value of the first power supply voltage signal is also compensated in the data voltage signal. The data voltage signal and the first power supply voltage signal are input into the pixel drive circuit. The drive current output by the pixel drive circuit is positively correlated with a difference between the data voltage signal and the first power supply voltage signal. Because the voltage value of the first power supply voltage signal is compensated in the data voltage signal, the data voltage signal can cancel the first power supply voltage signal. In this way, compensation for the voltage drop of the first power supply voltage signal is implemented. This helps improve luminance of the display picture of the display panel.

In addition, when the display module includes a plurality of source drivers, the plurality of source drivers receive gamma voltage signals output by a same calculation circuit, and compensation amounts of the gamma voltage signals received by the plurality of source drivers are the same, so that compensation amounts of data voltage signals generated by different source drivers are the same. In this way, a plurality of columns of sub-pixels corresponding to the different source drivers are displayed synchronously, to avoid screen splitting of a picture displayed on the display panel, and to improve quality of the displayed picture.

In addition, the display compensation circuit is integrated on the source circuit board, and only a corresponding circuit component needs to be added on the source circuit board. A quantity of added circuit components is small. Therefore, an occupied area of the source circuit board is small, and product costs are low. In addition, an area occupied by adding the compensation circuit on a display panel can be avoided, to avoid a decrease in pixel density of the display panel.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A display compensation circuit, comprising a generation circuit and a calculation circuit that are electrically connected, wherein
the generation circuit is configured to output a first reference gamma voltage and a second reference gamma voltage; and
the calculation circuit is configured to: receive a power supply voltage signal, the first reference gamma voltage, and the second reference gamma voltage, and output a first gamma voltage signal and a second gamma voltage signal, wherein
the first gamma voltage signal is a voltage sum of the power supply voltage signal and the first reference gamma voltage, and the second gamma voltage signal is a voltage difference between the power supply voltage signal and the second reference gamma voltage.

2. The display compensation circuit according to claim 1, wherein the calculation circuit comprises:
an adder, electrically connected to the generation circuit, and configured to calculate the voltage sum of the power supply voltage signal and the first reference gamma voltage, to obtain the first gamma voltage signal; and
a subtractor, electrically connected to the generation circuit, and configured to calculate the voltage difference between the power supply voltage signal and the second reference gamma voltage, to obtain the second gamma voltage signal.

3. The display compensation circuit according to claim 2, wherein the adder comprises a first operational amplifier, a first resistor, a second resistor, a third resistor, and a fourth resistor, wherein the first resistor is electrically connected to a non-inverting input terminal of the first operational amplifier, and the non-inverting input terminal is configured to receive the power supply voltage signal through the first resistor; the second resistor is connected between the generation circuit and the non-inverting input terminal; the third resistor is connected between a first voltage terminal and an inverting input terminal of the first operational amplifier; and the fourth resistor is connected between the inverting input terminal and an output terminal of the first operational amplifier.

4. The display compensation circuit according to claim 2, wherein the subtractor comprises a second operational amplifier, a fifth resistor, a sixth resistor, a seventh resistor, and an eighth resistor, wherein the fifth resistor is connected between a first voltage terminal and a non-inverting input terminal of the second operational amplifier; the sixth resistor is electrically connected to the non-inverting input terminal, and the non-inverting input terminal is configured to receive the power supply voltage signal through the sixth resistor; the seventh resistor is connected between the generation circuit and an inverting input terminal of the second operational amplifier; and the eighth resistor is connected between the inverting input terminal and an output terminal of the second operational amplifier.

5. The display compensation circuit according to claim 1, wherein the generation circuit comprises:
a signal generation sub-circuit, configured to output a reference voltage signal; and
a voltage divider sub-circuit, electrically connected to the signal generation sub-circuit, and configured to perform voltage division on the reference voltage signal, to obtain the first reference gamma voltage and the second reference gamma voltage.

6. The display compensation circuit according to claim 5, wherein the voltage divider sub-circuit comprises a first voltage divider resistor and a second voltage divider resistor that are disposed in series, and the first voltage divider resistor and the second voltage divider resistor are connected between the signal generation sub-circuit and a second voltage terminal; and
the voltage divider sub-circuit further comprises a first output terminal and a second output terminal, wherein the first output terminal is connected between the first voltage divider resistor and the second voltage divider resistor, and is configured to output the first reference gamma voltage; and the second output terminal is connected between the second voltage divider resistor and the second voltage terminal, and is configured to output the second reference gamma voltage.

7. A source circuit board, comprising a generation circuit and a calculation circuit that are electrically connected, wherein
the generation circuit is configured to output a first reference gamma voltage and a second reference gamma voltage; and
the calculation circuit is configured to: receive a power supply voltage signal, the first reference gamma voltage, and the second reference gamma voltage, and output a first gamma voltage signal and a second gamma voltage signal, wherein
the first gamma voltage signal is a voltage sum of the power supply voltage signal and the first reference gamma voltage, and the second gamma voltage signal is a voltage difference between the power supply voltage signal and the second reference gamma voltage.

8. The source circuit board according to claim 7, wherein the calculation circuit comprises:
an adder, electrically connected to the generation circuit, and configured to calculate the voltage sum of the power supply voltage signal and the first reference gamma voltage, to obtain the first gamma voltage signal; and
a subtractor, electrically connected to the generation circuit, and configured to calculate the voltage difference between the power supply voltage signal and the second reference gamma voltage, to obtain the second gamma voltage signal.

9. The source circuit board according to claim 8, wherein the adder comprises a first operational amplifier, a first resistor, a second resistor, a third resistor, and a fourth resistor, wherein the first resistor is electrically connected to a non-inverting input terminal of the first operational amplifier, and the non-inverting input terminal is configured to receive the power supply voltage signal through the first resistor; the second resistor is connected between the generation circuit and the non-inverting input terminal; the third resistor is connected between a first voltage terminal and an inverting input terminal of the first operational amplifier; and the fourth resistor is connected between the inverting input terminal and an output terminal of the first operational amplifier.

10. The source circuit board according to claim 8, wherein the subtractor comprises a second operational amplifier, a fifth resistor, a sixth resistor, a seventh resistor, and an eighth resistor, wherein the fifth resistor is connected between a first voltage terminal and a non-inverting input terminal of the second operational amplifier; the sixth resistor is electrically connected to the non-inverting input terminal, and the non-inverting input terminal is configured to receive the power supply voltage signal through the sixth resistor; the seventh resistor is connected between the generation circuit and an inverting input terminal of the second operational amplifier; and the eighth resistor is connected between the inverting input terminal and an output terminal of the second operational amplifier.

11. The source circuit board according to claim 7, wherein the generation circuit comprises:
a signal generation sub-circuit, configured to output a reference voltage signal; and
a voltage divider sub-circuit, electrically connected to the signal generation sub-circuit, and configured to perform voltage division on the reference voltage signal, to obtain the first reference gamma voltage and the second reference gamma voltage.

12. The source circuit board according to claim 11, wherein the voltage divider sub-circuit comprises a first voltage divider resistor and a second voltage divider resistor that are disposed in series, and the first voltage divider resistor and the second voltage divider resistor are connected between the signal generation sub-circuit and a second voltage terminal; and
the voltage divider sub-circuit further comprises a first output terminal and a second output terminal, wherein the first output terminal is connected between the first voltage divider resistor and the second voltage divider resistor, and is configured to output the first reference gamma voltage; and the second output terminal is connected between the second voltage divider resistor and the second voltage terminal, and is configured to output the second reference gamma voltage.

13. The source circuit board according to claim 11, wherein the source circuit board further comprises a time sequence controller, electrically connected to the signal generation sub-circuit; and
the time sequence controller is configured to control the signal generation sub-circuit to output the reference voltage signal.

14. A display module, comprising:
a display panel, comprising a plurality of data lines;
at least one source driver, electrically connected to the plurality of data lines; and
the display compensation circuit comprising a generation circuit and a calculation circuit that are electrically connected, wherein
the generation circuit is configured to output a first reference gamma voltage and a second reference gamma voltage; and
the calculation circuit is configured to: receive a power supply voltage signal, the first reference gamma voltage, and the second reference gamma voltage, and output a first gamma voltage signal and a second gamma voltage signal, wherein
the first gamma voltage signal is a voltage sum of the power supply voltage signal and the first reference gamma voltage, and the second gamma voltage signal is a voltage difference between the power supply voltage signal and the second reference gamma voltage;
wherein the calculation circuit of the display compensation circuit is electrically connected to the at least one source driver, and the calculation circuit is configured to transmit the first gamma voltage signal and the second gamma voltage signal to the at least one source driver.

15. The display module according to claim 14, wherein the display module further comprises a source circuit board, and the source circuit board comprises the display compensation circuit.

16. The display module according to claim 14, wherein the generation circuit of the display compensation circuit comprises the signal generation sub-circuit and the voltage divider sub-circuit; and
the source circuit board further comprises a time sequence controller, electrically connected to the signal generation sub-circuit; and the time sequence controller is configured to control the signal generation sub-circuit to output a reference voltage signal.
